(19) United States
(12) Patent Application Publication
(10) Pub. No.: US 2021/0053087 A1
(43) Pub. Date: Feb. 25, 2021

(54) ADHESIVE APPLICATION ROLLER

(71) Applicant: PHILIP MORRIS PRODUCTS S.A., Neuchatel (CH)

(72) Inventor: Christian Agostini, Bologna (IT)

(21) Appl. No.: 16/960,185

(22) PCT Filed: Jan. 23, 2019
(86) PCT No.: PCT/EP2019/051662

§ 371 Date: Jul. 6, 2020

(30) Foreign Application Priority Data
Feb. 8, 2018 (EP) 18155878.4

(51) Int. Cl. B05C 1/08; B05D 1/28; B05D 5/10; A24C 5/24; A24C 5/47; B65H 27/00; B65H 5/06

(52) U.S. Cl. CPC B05C 1/0808; B05C 1/0834; B05D 1/28; B65H 5/062; A24C 5/24; A24C 5/472; B65H 27/00; B05D 5/10

(57) ABSTRACT

An adhesive application roller (1) having a longitudinal axis of rotation (X). The roller (1) comprises plural separable discs (D₁-D_{N}) to provide a circumferential adhesive application surface (2) a first separable disc D₁ having a different width and/or diameter to a second separable disc D_{N}.

This invention relates to an adhesive application roller and to a method of applying an adhesive pattern to a sheet of material using the adhesive application roller.

In many industries it is necessary to adhere a sheet of material to a further article and/or to itself. In the tobacco industry, for example, sheet of material in the form of a wrapping paper or tipping paper is wrapped around and adhesively bonded to a tobacco rod and filter component in order to secure them together.

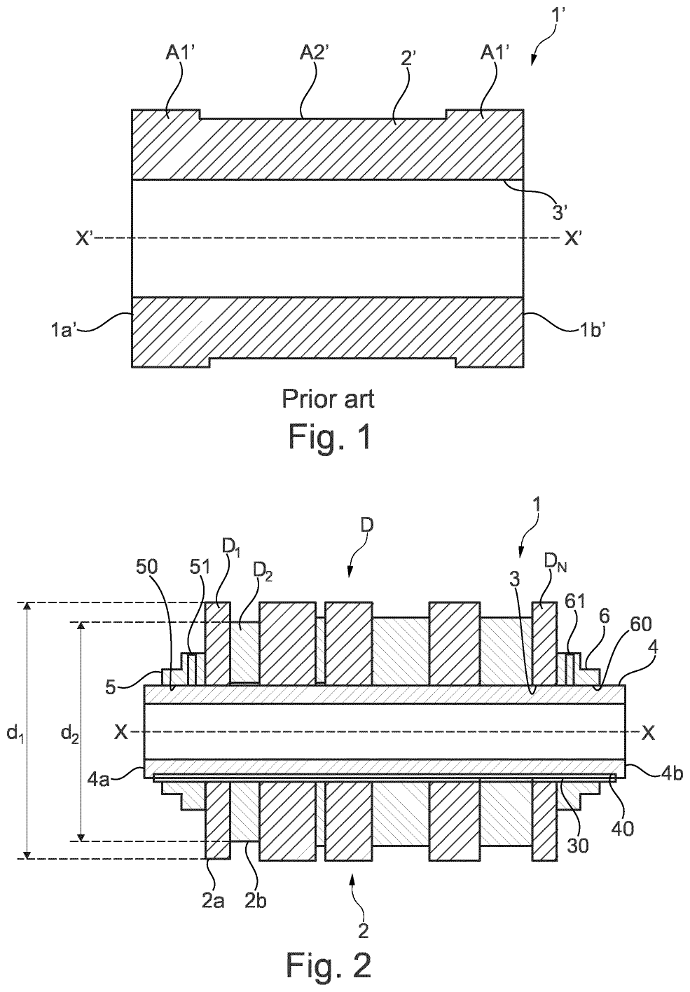

Adhesive can be applied to a sheet of material from an adhesive application roller 1′, for example as shown in FIG. 1. An adhesive application roller 1′ typically comprises a generally cylindrical shape with a longitudinal axis of rotation X′. The adhesive application roller 1′ extends from a first end 1a′ to a second end 1b′ along its longitudinal axis of rotation X′. An adhesive application surface 2′ is provided on the circumference of the adhesive application roller 1′. A central aperture 3′ may extend, longitudinally from the first end 1a′ to the second end 1b′ of the adhesive application roller 1′, along the longitudinal axis of rotation X′, for receipt of a shaft (not shown) for driving rotation of the adhesive application roller 1′, in use.

The adhesive application surface 2′ generally comprises at least one area A1′ having a relatively greater diameter and at least one area A2′ having a relatively lesser diameter. As will be appreciated, the diameters referred to are with respect to the longitudinal axis of rotation X′ of the adhesive application roller 1′. The difference in diameter between the area A1′ having a relatively greater diameter and the area A2′ having a relatively lesser diameter is dependent on, amongst others, the type of glue used and the type of sheet of material to which adhesive is intended to be applied. The difference in diameter may be in the order of micrometres. The configuration of the areas A1′, A2′ provides a pattern. In use, adhesive is applied to the adhesive application surface 2′ which is then rolled over a sheet of material, to which the adhesive is then transferred. Adhesive applied to the areas A1′ having relatively greater diameter transfers to the sheet of material, whilst adhesive applied to the areas A2′ having relatively lesser diameter does not transfer to the sheet of material. In this way, adhesive can be selectively applied to a sheet of material according to a desired pattern. Such a pattern may be useful to control the areas at which the sheet of material is adhered to a further article and/or to itself.

Adhesive application rollers 1′ are manufactured prior to their installation and use in an adhesive application station. This manufacture entails machining of the adhesive application surface 2′ to form the required pattern, e.g. the required diameters of areas A1′, A2′ of relatively greater and lesser diameter respectively and the required arrangement of those areas A1′, A2′. When it is necessary to apply adhesive in tightly controlled amounts and locations the pattern formed on the adhesive application surface 2′ must be machined to tightly controlled tolerances. Moreover, the surface finish of the adhesive application surface 2′ may need to be particularly smooth and uninterrupted in each or all of the areas A1′, A2 of the pattern. Such a surface finish may necessitate further processing of the adhesive application surface 2′, further increasing the expense and time required for the adhesive application roller's 1′ manufacture.

As will be appreciated, it may be necessary or desirable to alter the pattern on the adhesive application surface 2′, for example to use different types of adhesive and/or to adhere different types of sheet of material and/or to adhere sheets of material to different types or configurations of articles. In the tobacco industry, for example, the arrangement of the tobacco rod and the filter component may alter which may in turn necessitate a change in the pattern of adhesive application to a wrapping paper band. The requirement for adhesive application rollers 1′ having a different pattern on their adhesive application surface 2′ are particularly pronounced when manufacturing reduced quantities of plural different types of articles, for example for the purpose of research and development. However, for each required pattern of adhesive application a different adhesive application roller 1′ having a different pattern on its adhesive application surface 2′ must be provided. Manufacture of a different adhesive application roller 1′ is, however, both time consuming and expensive.

It would be desirable to provide an adhesive application roller for applying an adhesive pattern to a sheet of material and/or a method of applying an adhesive pattern to a sheet of material which at least partially mitigates against one or more of the above-identified problems.

According to an aspect of the invention there is provided a method of applying an adhesive pattern to a sheet of material, the method comprising selecting plural separable discs to form a circumferential adhesive application surface, applying adhesive to the circumferential adhesive application surface of the discs and transferring adhesive from the circumferential adhesive application surface of the discs to a sheet of material.

Advantageously, adhesive may therefore be applied in the requisite adhesive pattern to a sheet of material relatively more rapidly and at relatively reduced expense. Selecting plural separable discs to form the circumferential adhesive application surface with the requisite adhesive pattern takes relatively less time and is relatively less expensive than machining the circumferential surface of an adhesive application roller in order to form an adhesive application surface having the desired pattern. Accordingly, the necessary adhesive application roller may be provided more rapidly and at less expense and, hence, adhesive may be applied to the sheet of material with less delay and at reduced expense.

Furthermore, repair and/or cleaning of the adhesive application roller may be achieved relatively more rapidly and readily than is the case with prior art adhesive application rollers. For example, provision of plural separable discs may allow only those discs which are dirty (e.g. coated with adhesive or other contaminates) to be removed for cleaning. Additionally or alternatively, provision of plural separable discs may allow only those discs with are damaged or worn to be removed for replacement or repair. The remaining discs may remain ready for use, consequently reducing the down-time of the adhesive application roller. Moreover, cleaning and/or repair of the plural separable discs may be relatively more rapid when the plural separable discs are separated than is possible with prior art adhesive application rollers. Accordingly, downtime of the adhesive application roller may be relatively reduced.

As used herein, the term ‘sheet’ relates to an element having a width and length substantially greater than its thickness.

As used herein, the term ‘separable’ is intended to mean that the discs are discrete elements and are capable of being moved relatively away from one another when not in use for adhesive application. As used herein, the term ‘disc’ refers to a generally cylindrical element having a width which is typically less than its diameter.

Each of the discs may comprise a central aperture for location of the discs on a shaft for driving the discs. Each disc may comprise a key way.

As used herein, the phrase ‘key way’ relates to a first keying feature comprising an aperture or slot which is configured to be engaged, in use, by a second keying feature, e.g. a key provided on a shaft. When engaged together, the keying features prevent the discs from rotating relative to and about the shaft.

The method may comprise removing one or more of the plural separable discs. The method may comprise exchanging the removed one or more of the plural separable discs for one or more further separable discs, for example thereby to provide a different adhesive pattern.

In some embodiments, the method may comprise selecting one or more further separable discs, for example dependent upon a desired further adhesive pattern.

In some embodiments, transferring adhesive from the circumferential adhesive application surface of the discs to a sheet of material comprises transferring adhesive to a wrapping or tipping paper for an aerosol generating device.

According to an aspect of the invention, there is provided an adhesive application roller having a longitudinal axis of rotation, wherein the roller comprises plural separable discs to provide a circumferential adhesive application surface.

According to an aspect of the invention, there is provided an adhesive application roller for mounting on a shaft and having a longitudinal axis of rotation, wherein the roller comprises plural separable discs to provide a circumferential adhesive application surface.

In some embodiments, each of the separable discs may have a width and diameter. A first of the plural separable discs may have a width and/or diameter different to the width and/or diameter of a second of the plural separable discs. The first of the plural separable discs may have a first pattern provided on its circumferential surface. The second of the plural separable discs may have a second pattern provided on its circumferential surface. The first pattern may differ from the second pattern. The first and/or the second pattern may comprise one or more depressions or grooves and/or projections or ribs. The first and/or the second pattern may comprise a first portion having a first diameter and a second portion having a second diameter, for example where the second diameter may be less than the first diameter. The first and/or the second portion may be at or adjacent the peripheral edge of the circumferential surface.

The first of the plural separable discs may be made from a first material and a second of the plural separable discs may be made from a second material. The first of the plural separable discs may be made from a first material having a first density and the second of the plural separable discs may be made from a second material having a second density different to the first density, e.g. more or less dense than the first density.

A first of the plural separable discs may be spaced from a second of the plural separable discs, for example by a spacer disc. Where provided, the spacer disc may have a diameter less than either of the diameters of the first and second of the plural separable discs. The spacer disc may be formed from a different material than one or either of the first and second of the plural separable discs.

In some embodiments, one, some or each of the separable discs may comprise a first keying feature for engagement with a corresponding portion (e.g. a second keying feature) of a shaft. One of the first and second keying feature may comprise a key way. The other of the second and first keying feature may comprise a key, e.g. configured to engage with the key way, in use. In some embodiments, each of the separable discs may comprise a key way for engagement with a corresponding portion of a shaft.

The adhesive application roller may comprise a shaft. Where a shaft is provided, the shaft may comprise the second keying feature. The shaft may be configured or arranged to be driven to rotate, in use. The shaft may be connected or connectable to a source of torque.

Advantageously, the keying features maintain, in use, the radial orientation of the plural separable discs relative to the shaft, when said shaft is engaged with the plural separable discs. In this way, torque rotating the shaft, in use, can be transmitted to the plural separable discs engaged thereabout, thereby causing the plural separable discs to rotate with the shaft.

The adhesive application roller may further comprise a first clamp and a second clamp, for example where the plural separable discs may be located therebetween. The first and/or the second clamp may be secured (e.g. removably) or securable (e.g. removably) to the shaft and/or to one or more of the plural separable discs.

The adhesive application roller may comprise one or more securement means or securements. The one or more securement means or securements may be configured to secure the plural separable discs together and/or to the or a shaft. Where one or more securement means or securements are provided the method may comprise using the one or more securement means or securements to secure the plural separable discs to the shaft for rotation. Where one or more securement means or securements are provided the method may comprise using the one or more securement means or securements to secure the plural separable discs together. The one or more securement means or securements may comprise one or more threaded members. In embodiments, the method may comprise threadably engaging the one or more threaded members to secure the plural separable discs together and/or to the shaft for rotation.

According to an aspect of the invention, there is provided an adhesive application station comprising an adhesive application roller as described herein. The adhesive application station may comprise a shaft for rotating the adhesive application roller. The adhesive application station may comprise a reservoir for holding adhesive. The reservoir may comprise a bath. The bath may comprise adhesive. The adhesive application station may comprise a drive for rotating the adhesive application roller in contact with adhesive within the reservoir (where provided). The adhesive application station may comprise one or more transfer rollers, for example for transferring adhesive from the bath to the adhesive application roller. The adhesive application station may comprise a further roller, e.g. a guide roller. The further roller may be arranged or arrangeable, in use, to guide a sheet of material against the adhesive application surface of the adhesive application roller.

The adhesive application roller and adhesive application station may be configured for applying adhesive to wrapping or tipping papers for use in the tobacco industry.

All scientific and technical terms used herein have meanings commonly used in the art unless otherwise specified. The definitions provided herein are to facilitate understanding of certain terms used frequently herein.

Throughout the description and claims of this specification, the words “comprise” and “comprising” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

For the avoidance of doubt, any of the features described herein apply equally to any aspect of the invention. Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one aspect or embodiment of the invention are applicable to all aspects or embodiments, unless such features are incompatible.

The invention will now be further described, by way of example only, with reference to the accompanying drawings, in which:

FIG. 1 is a schematic cross-section side view of a prior art adhesive application roller;

FIG. 2 is a schematic cross-section side view of an adhesive application roller according to an embodiment of the invention;

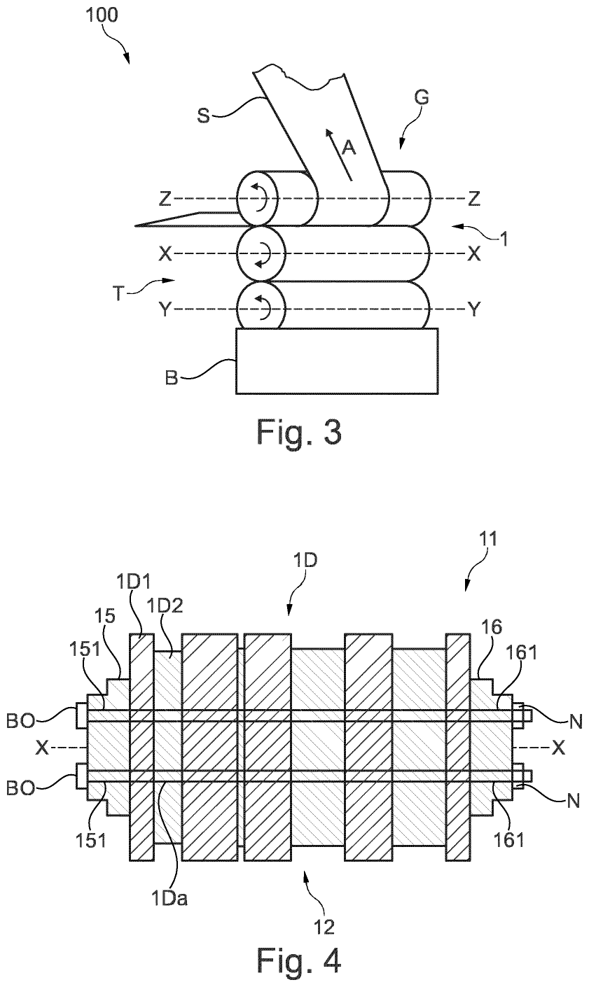

FIG. 3 is a perspective view of an adhesive application station comprising the adhesive application roller shown in FIG. 2;

FIG. 4 is a schematic cross-section side view of an adhesive application roller according to an embodiment of the invention; and

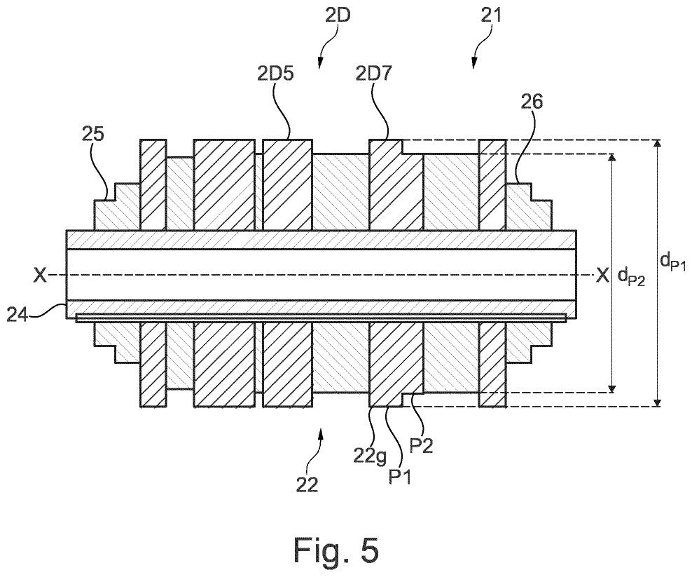

FIG. 5 is a schematic cross-section side view of an adhesive application roller according to an embodiment of the invention.

Referring now to FIG. 2, there is shown an adhesive application roller 1 according to an embodiment of the invention. The adhesive application roller 1 comprises plural separable discs D₁-D_{N} (D₁, D₂ . . . D_{N}) disposed about a shaft 4, and first and second clamps 5, 6. The adhesive application roller 1 has a longitudinal axis of rotation X extending through the shaft 4, plural separable discs D₁-D_{N} and first and second clamps 5, 6.

Each of the plural separable discs D₁-D_{N} comprises a central aperture 3 through its thickness, where the central apertures 3 correspond to, and are configured to receive therewithin, the outer surface of the shaft 4.

Although only the first and second discs D₁, D₂ of the plural separable discs D₁-D_{N} are described in detail in the following description it will be appreciated that the remaining discs of the plural separable discs D₃-D_{N} have similar features.

First and second discs D₁, D₂ of the plural separable discs D₁-D_{N} each comprise a circumferential surface 2a, 2b. Together the circumferential surfaces 2a, 2b (and indeed the circumferential surfaces 2a-2ₓ of all of the plural separable discs D₁-D_{N}) comprise a circumferential adhesive application surface 2 of the adhesive application roller 1.

The first disc D₁ has a first diameter d₁ and a first width w₁. The second disc D₂ has a second diameter d₂ and a second width w₂. The second diameter d₂ is less than is the first diameter d₁. The second width w₂ is greater than is the first width w₁. The second disc D₂ provides or comprises a spacer, configured to space the first disc D₁ from further of the plural separable discs D₃-D_{N}.

The shaft 4 is generally cylindrical and extends from a first end 4a to a second end 4b. The shaft 4 is configured to be connected to a source of torque (not shown), in use. A key 40 extends from the circumferential outer surface of the shaft 4 and extends longitudinally therealong.

Each of the plural separable discs D₁-D_{N} comprises a key way 30 into its central aperture 3. The key ways 30 are shaped, sized and oriented to correspond to the key 40 on the shaft 4 for ensuring that the discs D₁-D_{N} are not relatively rotatable with respect to the shaft 4. The key may be provided on the disc and the keyway on the shaft 4.

The first and second clamps 5, 6 each comprise a central aperture 50, 60 through their thickness, where each central aperture 50, 60 corresponds to, and is configured to receive therewithin, the outer surface of the shaft 4. The first and second clamps 5, 6 each comprise an abutment surface, configured to abut, in use, an annular shaped surface of one of the plural separable discs D₁-D_{N}. Each of the first and second clamps 5, 6 also comprise a securement aperture 51, 61 through its thickness in a direction perpendicular to the longitudinal axis of rotation X. Each securement aperture 51, 61 is threaded along at least part of its length.

Prior to use, the adhesive application roller 1 is assembled. The first clamp 5 is slid onto the first end 4a of the shaft 4. A securement, which in this embodiment is a grub screw (not shown), is threadably engaged into the first clamp's 5 securement aperture 51 and is tightened until the grub screw engages the outer surface of the shaft 4. In this way, the first clamp 5 is secured in position adjacent the first end 4a of the shaft 4.

The central aperture 3 through the first disc D₁ is then aligned with the second end 4b of the shaft 4 and is moved axially thereonto. The first disc D₁ and the shaft 4 are angularly aligned so that the key 40 on the shaft 4 aligns with the key way 30 in the first disc D₁. In this orientation, the first disc D₁ is slid axially along the shaft 5, from the second end 4b thereof toward the first end 4a, until an annular surface of the first disc D₁ abuts the abutment surface of the first clamp 5. Each of the remaining plural separable discs D₂-D_{N} is then moved onto the shaft 4, in turn, in a similar manner. The second clamp 6 is then moved onto the second end 4b of the shaft 4 and moved along the shaft 4 until the abutment surface of the second clamp 6 abuts an annular surface of that of the plural separable discs D₁-D_{N} closest to the second end 4b of the shaft 4. The second clamp 6 is then secured to the shaft 4 in the same manner as described above in respect of the first clamp 5.

Referring now to FIG. 3, there is shown an adhesive application station 100 comprising the adhesive application roller 1 shown in FIG. 2, a guide roller G, a transfer roller T, a bath B and a sheet of material S. As will be appreciated, the adhesive application roller 1 comprises the plural separable discs D₁-D_{N}, and is shown in simplified form shown in FIG. 3 for the sake of illustrative purposes, only.

The transfer roller T is arranged in the bath B, such that adhesive provided in the bath B contacts the outer surface of the transfer roller T. The adhesive application roller 1 and the transfer roller T are arranged such that their respective longitudinal axes of rotation X, Y are parallel and the circumferential surface of the transfer roller T contacts the circumferential adhesive application surface 2 of the adhesive application roller 1. The guide roller G is arranged so that its longitudinal axis of rotation Z is parallel to the longitudinal axis of rotation X of the adhesive application roller 1. The circumferential surface of the guide roller G is adjacent the circumferential adhesive application surface 2 of the adhesive application roller 1, thereby forming a nip therebetween.

In use, each of the rollers T, 1, G are driven to rotate by a source of torque (not shown). The transfer roller T and the guide roller G are driven to rotate in a first direction (e.g. a clockwise direction), while the adhesive application roller 1 is driven to rotate in an opposite direction (e.g. a counter-clockwise direction). The transfer roller T rotates in the bath B, whereby adhesive temporarily adheres to its outer surface. Adhesive is transferred to the circumferential adhesive application surface 2 of the adhesive application roller 1 from the transfer roller T, at and adjacent the point of contact therebetween. Adhesive is only transferred to the circumferential surface 2a of those of the first disc D₁ and those of the plural separable discs D₁-D_{N} having a relatively greater diameter. The second disc D₂ and those of the plural separable discs D₂-D_{N} having a relatively lesser diameter to that of the first disc D₂ do not contact the transfer roller T and, consequently, adhesive is not transferred thereto.

The sheet of material S is drawn toward the adhesive application station 100 in the direction of arrow A and is guided by the guide roller G into the nip between the guide roller G and the adhesive application roller 1, where adhesive is transferred to the sheet of material S. The adhesive is transferred in a pattern corresponding to the pattern provided on the circumferential adhesive application surface 2 of the adhesive application roller 1.

When it is necessary to alter the pattern on the circumferential adhesive application surface 2 of the adhesive application roller 1 the combination of the plural separable discs D₁-D_{N} is altered.

The second clamp 6 is unsecured from the shaft 4 by undoing the grub screw securing it thereto. The second clamp 6 is then slid axially off the second end 4b of the shaft 4 and removed therefrom. One, some or each of the plural separable discs D₁-D_{N} is then removed from the shaft 4 by axially sliding it or them off the second end 4b thereof. A different combination of plural separable discs D₁-D_{N} is then added to the shaft 4 by sliding them axially thereonto from the second end 4b thereof. The second clamp 6 is once more slid axially onto the second end 4b of the shaft 4. The second clamp 6 is then secured to the shaft 4 by the grub screw, as described above, thereby securing the plural separable discs D₁-D_{N} to the shaft 4.

Referring now to FIG. 4, there is shown an adhesive application roller 11 according to a further embodiment of the invention in which like features to those described above in respect of the adhesive application roller 1 shown in FIG. 2 are denoted by like features preceded by a ‘1’, which will not be described further herein. The adhesive application roller 11 shown in FIG. 4 differs from that shown in FIG. 2 in that a shaft is not provided. Instead, the plural separable discs 1D₁-1D_{N} are secured together by bolts BO which run parallel to the longitudinal axis of rotation X of the adhesive application roller 11. The clamps 15, 16 each comprise securement apertures 151, 161 through their thickness which are parallel to the longitudinal axis of rotation X. In this embodiment, the plural separable discs 1D₁-1D_{N} are not hollow and are each absent a central aperture through their thickness and are also absent a key way. Instead, each of the plural separable discs 1D₁-1D_{N} comprises securement apertures 1Da through their thickness which correspond in size, shape and location to the securement apertures 151, 161 through the clamps 15, 16.

Prior to use, the required arrangement of plural separable discs 1D₁-1D_{N} is formed. The first and second clamps 15, 16 are positioned at either end of the arrangement of plural separable discs 1D1₁-1D_{N} and a bolt BO is fed through a securement aperture 151 through the first clamp 15 and thence through a securement aperture 1Da through each of the plural separable discs 1D₁-1D_{N} and through a securement aperture 161 through the second clamp 16 until the end of the bolt BO projects beyond the second clamp 16. Bolts BO are fed through each of the other securement apertures 151 in the first clamp 15 and their corresponding securement apertures 1Da, 161 in the plural separable discs 1 D1₁-1D_{N} and the second clamp 16, respectively. Nuts N are then secured to the free ends of the bolts BO. Tightening of the nuts N secures the clamps 15, 16 and plural separable discs 1D₁-1D_{N} together.

The first clamp 15 is then connected to a transmission shaft (not shown) for transmitting torque to the adhesive application roller 11. The connection may be any type suitable to transmit torque from the transmission shaft to the adhesive application roller 11. The second clamp 16 is connected to a support shaft (not shown) for supporting the adhesive application roller 11 during driven rotation thereof. Adhesive can then be applied to a sheet of material S as described above in respect of adhesive application roller 11.

When it is necessary to alter the pattern on the circumferential adhesive application surface 12 of the adhesive application roller 11, the nuts N are removed from the bolts BO and the bolts BO are removed from the clamps 15, 16 and plural separable discs 1D₁-1D_{N}. A different arrangement of plural separable discs 1D₁-1D_{N} is then formed and secured together by the clamps 15, 16, bolts BO and nuts N as described above in respect of the previous arrangement.

As will be appreciated, in embodiments, one or more of the bolts BO may be fed through the first clamp 15 first and then each disc of the plural separable discs 1D₁-1D_{N} slid onto the bolt or bolts BO in turn in order to form the arrangement of the plural separable discs 1D. Additionally or alternatively, the clamps 15, 16 and plural separable discs 1D₁-1D_{N} may be secured together using alternative securements, for example one or more screws.

Referring now to FIG. 5, there is shown an adhesive application roller 21 according to a further embodiment of the invention in which like features to those described above in respect of the adhesive application roller 1 shown in FIG. 2 are denoted by like features preceded by a ‘2’, which will not be described further herein. The adhesive application roller 21 shown in FIG. 5 differs from that shown in FIG. 2 in that the seventh disc 2D₇ of the plural separable discs 2D₁-2D_{N} has a different pattern on its circumferential surface 22g than does the fifth disc 2D₅. The circumferential surface 22g of the seventh disc 2D₇ comprises a first portion P1 having a first diameter d_{P1} and a second portion P2 having a second diameter d_{P2}, where the second diameter d_{P2} is less than the first diameter d_{P1}.

Accordingly, in use, adhesive will be transferred only to the first portion P1 of the circumferential surface 22g of the seventh disc 2D₇ and hence, only from the first portion P1 of the circumferential surface 22g of the seventh disc 2D₇ to the sheet of material S. A pattern may thereby be formed using a relatively lesser number of plural separable discs 2D₁-2D_{N}. Accordingly, the formation of a required pattern may be made relatively more rapidly. Consequently, the expense of downtime of the adhesive application station 100 within which the adhesive application roller 21 is used is relatively reduced.

It will be appreciated that although only the seventh disc 2D₇ is shown as comprising different first and second portions P1, P2 of its circumferential surface 22g this need not be the case and, instead, one, some or each of the other of the plural separable discs 2D₁-2D_{N} may also comprise different first and second portions on its or their circumferential surface(s) 22. Additionally or alternatively, the configuration of the seventh disc 2D₇ is only one example of a disc having a different pattern on its circumferential surface 22g. In embodiments, the seventh disc 2D₇ (and/or one, some or each of the other plural separable discs 2D₁-2D_{N}) may have more than two portions P1, P2 having different diameters d_{P1}, dₚ₂. In embodiments, the second portion P2 may be bound on either side by first portions P1. In embodiments, the circumferential surface of one, some or each of the plural separable discs 2D₁-2D_{N} may have a diameter which gradually increases and/or increases, for example in the first portion P1, in the second portion P2 and/or from the first portion P1 to the second portion P2.

While first and second clamps 5, 15, 25, 6, 16, 26 are described, these are not essential to the invention. The plural separable discs D₁-D_{N}, 1D₁-1D_{N}, 2D₁-2D_{N} may, additionally or alternatively, be directly secured together The plural separable discs D₁-D_{N}, 1D₁-1D_{N}, 2D₁-2D_{N} may, additionally or alternatively, be secured to the shaft 4, 24 (where provided).

In each case the discs D₁-D_{N}, 1D₁-1D_{N}, 2D₁-2D_{N} may be selected to provide a particular adhesive application pattern. If a further pattern is required or desired, some or each of the discs D₁-D_{N}, 1D₁-1D_{N}, 2D₁-2D_{N} can be exchanged for other discs D₁-D_{N}, 1D₁-1 D_{N}, 2D₁-2D_{N}, or disc positions exchanged, thereby to form a further adhesive application pattern. The exchange or change of discs D₁-D_{N}, 1D₁-1D_{N}, 2D₁-2D_{N} can be undertaken quickly and conveniently ensuring that the roller is ready for use applying the new pattern.

It will also be appreciated by those skilled in the art that any number of combinations of the aforementioned features and/or those shown in the appended drawings provide clear advantages over the prior art and are therefore within the scope of the invention described herein. For example, the connection of the plural separable discs 1D₁-1D_{N} shown in FIG. 4 is equally applicable to the adhesive application roller 21 shown in FIG. 5.

The schematic drawings are not necessarily to scale and are presented for purposes of illustration and not limitation. The drawings depict one or more aspects described in this disclosure. However, it will be understood that other aspects not depicted in the drawings fall within the scope of this disclosure. It will be appreciated that the particular arrangements of plural separable discs D₁-D_{N}, 1D₁-1D_{N}, 2D₁-2D_{N} shown in the drawings are for illustrative purposes only and that the number, sequence, dimensions and/or the patterns on the circumferential surfaces of the plural separable discs D₁-D_{N}, 1D₁-1D_{N}, 2D₁-2D_{N} may differ from those shown in the drawings.

1. A method of applying an adhesive pattern to a sheet of material, the method comprising selecting plural separable discs to form a circumferential adhesive application surface, applying adhesive to the circumferential adhesive application surface of the discs and transferring adhesive from the circumferential adhesive application surface of the discs to a wrapping paper or tipping paper for an aerosol generating device.

2. A method according to claim 1, comprising removing one or more of the plural separable discs and exchanging it or them for one or more further separable discs, thereby to provide a different adhesive pattern.

3. A method according to claim 1 comprising securing the plural separable discs to a shaft for rotation.

4. An adhesive application station comprising an adhesive application roller having a longitudinal axis of rotation, wherein the roller comprises plural separable discs to provide a circumferential adhesive application surface, wherein the adhesive application station is configured for applying adhesive to wrapping or tipping paper for an aerosol generating device.

5. An adhesive application station according to claim 4, wherein the first of the plural separable discs has a first pattern provided on its circumferential surface and the second of the plural separable discs has a second pattern provided on its circumferential surface.

6. An adhesive application station according to claim 4, wherein the first of the plural separable discs is made from a first material and a second of the plural separable discs is made from a second material.

7. An adhesive application station according to claim 4 wherein a first of the plural separable discs is spaced from a second of the plural separable discs by a spacer disc.

8. An adhesive application station according to claim 7, wherein the spacer disc has a diameter less than either of the diameter of the first and second of the plural separable discs.

9. An adhesive application station according to claim 4, wherein each of the separable discs comprises a key way for engagement with a corresponding portion of a shaft.

10. An adhesive application station according to claim 4, further comprising a first clamp and a second clamp, the plural separable discs being located therebetween.

11. An adhesive application station according to claim 4, comprising a reservoir for holding adhesive and preferably a drive for rotating the adhesive application roller in contact with adhesive within the reservoir.

12. An adhesive application station according to claim 4, wherein each of the separable discs has a width and diameter and wherein a first of the plural separable discs has a width and/or diameter different to the width and/or diameter of a second of the plural separable discs.
